(19) United States
(12) Patent Application Publication
(10) Pub. No.: US 2023/0409879 A1
(43) Pub. Date: Dec. 21, 2023

(54) METHOD AND APPARATUS RELATING TO AGENTS

(71) Applicant: Telefonaktiebolaget LM Ericsson (publ), Stockholm (SE)

(72) Inventors: Amadeu do Nascimento JUNIOR, Indaiatuba (BR); Jean Paulo MARTINS, Indaiatuba (BR); Alberto HATA, Campinas SP (BR); Klaus RAIZER, Indaiatuba (BR); Ricardo da Silva SOUZA, Indaiatuba (BR)

(21) Appl. No.: 18/036,428

(22) PCT Filed: Nov. 17, 2020
(86) PCT No.: PCT/EP2020/082434

§ 371 Date: May 11, 2023

(51) Int. Cl. G06N 3/0455; G06N 3/094; G06N 3/098; G06N 3/0475

(52) U.S. Cl. CPC G06N 3/0455; G06N 3/094; G06N 3/098; G06N 3/0475

(57) ABSTRACT

A management node for use with a cognitive layer (CL) having agents. The agents have respective agent information indicating type(s) of input data required by a model implemented by the agent, parameter(s) of the system that are to be improved by the agent, type(s) of output data provided by the model and a data distribution for the agent. A method includes (i) selecting a set of similar agents that improve a first parameter of the system: (ii) for a first agent and a second agent in the selected set of similar agents, comparing the data distribution for the first agent to the data distribution for the second agent to determine a relationship: (iii) initiating generation of the candidate agent(s) based on the relationship; and (iv) determining whether to replace one or both of the first agent and the second agent with the one or more candidate agents.

### TECHNICAL FIELD

This disclosure relates to agents used to provide output data relating to an improvement of a parameter for a system, such as a telecommunication network, and in particular to a method and apparatus for reducing a number of agents used to provide output data while maintaining and/or improving the quality of the agents.

### BACKGROUND

Systems like telecommunication networks are inherently complex and are composed of several subsystems. Managing such systems is a complex task that requires tools to offload some of this complexity from human operators by using artificial intelligence (AI) and automation. In this context, a Cognitive Layer (CL, also known as Cognitive Operations Support Systems (OSS)) is an apparatus able to bring together machine reasoning and machine learning (ML) algorithms to ease the management of telecommunication networks, and in particular the setting of operational parameters for the telecommunication network. A CL can be regarded as an enabler for a Cognitive Network in the sense that it augments a communication network with a knowledge plane. This knowledge plane has ontological descriptions of different communication network domains allowing end-to-end views of various scenarios through its reasoning mechanism. In its knowledge base, the CL also contains information about the cognition loops used to optimize, maintain and operate the network. The cognition loops are usually a composition of agents that employ artificial intelligence methods for decision making, estimation, and learning tasks demanded by the loops.

The cognitive layer works by coupling descriptions to agents and adding mechanisms to reason upon these descriptions. With this combination, tasks composed of several steps can be described in high-level terms, and the cognitive layer can find suitable agents to fulfil the task. In such scenarios, the search for the right agent to accomplish a given task is a difficult problem, whose complexity increases as the number of available agents increases. Moreover, if coordination or cooperation among different agents is required to fulfil a common goal, then complexity also escalates quickly.

To enable understanding of the problems with having many agents available to solve a particular problem in the CL, an example is provided. In this example, a high-level goal is given to the CL to optimise a media service Quality of Experience (QoE). Using its reasoning mechanisms, the CL identifies ‘throughput’ as the parameter to be improved. To fulfil that task, the CL follows these steps: call agents to propose actions to improve throughput, call agents to evaluate the proposed actions, and call agents to choose and implement an action. By using the descriptions of the agents the CL identifies that, for example, five agents can propose actions to improve throughput and so the CL gathers the proposals from these agents. Then, the impact of each proposal is evaluated, one proposal is chosen, and an agent finally implements the proposal.

### SUMMARY

In the above example, it has been found that some problems may arise due to having many different proposals. In particular, in each proposal very different actions may result in similar impacts, making an automatic decision to take one action over other harder. Further, five agents were called and just one proposal is selected; therefore by calling five agents, more resources (computation time, data transfer, energy) are used. In addition, some agents may provide efficient recommendations for particular situations and may not be used often.

Therefore there is a need for improvements in relation to a cognitive layer of a telecommunication network, and in particular to reducing a number of agents in the cognitive layer while maintaining and/or improving the quality of the agents in the cognitive layer.

The techniques described herein propose a method to reduce the number of agents in a cognitive layer that can solve similar problems, since through agent/model composition the number of agents can be reduced while keeping equivalent, or better, performance. Thus, to cope with scalability issues, the number of agents can be reduced by using their descriptions to identify similar agents, and techniques such as federated averaging or transfer learning can be used to combine them.

However, more than simply reducing the total number of agents, the disclosed techniques can also improve the overall quality of the agents. An aim is to enable the composition of agents that are more robust against generalisation issues, and to allow the composition of new models from other AI agents or legacy (i.e. non-AI) agents. Reducing the number of agents that can solve the same/similar problem also reduces the total number of solutions for a given problem.

According to a first aspect, there is provided a computer-implemented method performed by a management node for use with a cognitive layer, CL, that is used to improve or manage a system. The CL comprises a plurality of agents. The agents have respective agent information, the respective agent information indicating one or more types of input data required by a model implemented by the agent, one or more parameters of the system that are to be improved by the agent, one or more types of output data provided by the model implemented by the agent and a data distribution for the agent. The method comprises (i) selecting a set of similar agents from the plurality of agents that improve a first parameter of the system, wherein similar agents are selected on the basis of similarities or matches in the one or more types of input data, the one or more types of parameters of the system improved by the agent, and the one or more types of output data; (ii) for a first agent and a second agent in the selected set of similar agents, comparing the data distribution for the first agent to the data distribution for the second agent to determine a relationship between the data distributions; (iii) initiating generation of one or more candidate agents based on the determined relationship; and (iv) determining whether to replace one or both of the first agent and the second agent with the one or more candidate agents based on a comparison of a performance of the one or more candidate agents with respect to a performance of the first agent and/or a performance of the second agent.

According to a second aspect, there is provided a computer program product comprising a computer readable medium having computer readable code embodied therein. The computer readable code is configured such that, on execution by a suitable computer or processor, the computer or processor is caused to perform the method of the first aspect or any embodiment thereof.

According to a third aspect, there is provided a management node for use with a cognitive layer, CL, that is used to improve or manage a system. The CL comprises a plurality of agents. The agents have respective agent information, the respective agent information indicating one or more types of input data required by a model implemented by the agent, one or more parameters of the system that are to be improved by the agent, one or more types of output data provided by the model implemented by the agent and a data distribution for the agent. The management node is configured to: (i) select a set of similar agents from the plurality of agents that improve a first parameter of the system, wherein similar agents are selected on the basis of similarities or matches in the one or more types of input data, the one or more types of parameters of the system improved by the agent, and the one or more types of output data; (ii) for a first agent and a second agent in the selected set of similar agents, compare the data distribution for the first agent to the data distribution for the second agent to determine a relationship between the data distributions; (iii) initiate generation of one or more candidate agents based on the determined relationship; and (iv) determine whether to replace one or both of the first agent and the second agent with the one or more candidate agents based on a comparison of a performance of the one or more candidate agents with respect to a performance of the first agent and/or a performance of the second agent.

According to a fourth aspect, there is provided a management node for use with a cognitive layer, CL, that is used to improve or manage a system. The CL comprises a plurality of agents. The agents have respective agent information, the respective agent information indicating one or more types of input data required by a model implemented by the agent, one or more parameters of the system that are to be improved by the agent, one or more types of output data provided by the model implemented by the agent and a data distribution for the agent. The management node is configured to: (i) select a set of similar agents from the plurality of agents that improve a first parameter of the system, wherein similar agents are selected on the basis of similarities or matches in the one or more types of input data, the one or more types of parameters of the system improved by the agent, and the one or more types of output data; (ii) for a first agent and a second agent in the selected set of similar agents, compare the data distribution for the first agent to the data distribution for the second agent to determine a relationship between the data distributions; (iii) initiate generation of one or more candidate agents based on the determined relationship; and (iv) determine whether to replace one or both of the first agent and the second agent with the one or more candidate agents based on a comparison of a performance of the one or more candidate agents with respect to a performance of the first agent and/or a performance of the second agent.

The techniques described herein can provide a method capable of saving computational resources needed to execute a single decision-making cycle in a CL by reducing the number of agents able to provide solutions. With fewer agents, less processing power and/or memory are required for a CL's decision loop, less data-transfer is needed, and storage and/or processing can be saved in the reasoning mechanism due to less agent descriptions being available in the knowledge base. All these effects are achieved by reducing the number of agents using embodiments that allows CL to keep its capacity to solve problems. In particular embodiments, the CL is part of, or associated with, a telecommunication network, and thus the techniques can achieve any of: a reduction of computational resource usage in the telecommunication network/CL, a reduction of memory usage in the telecommunication network/CL and a reduction in data transfer in the in the telecommunication network/CL. Some embodiments can improve the performance of the available agents. Some embodiments provide support for some aspects of auto-ML training. For example, embodiments allow the automatic retraining of algorithms/models using different data distribution(s), and/or allow the automatic training of models for more diverse data distributions. Some embodiments can enable the bootstrapping of new or existing non-ML models into a ML system. For example if a ML agent and a non-ML agent with similar descriptions are using similar data distributions, the knowledge from the non-ML model can be used in the composition of models. Furthermore, the techniques can be used separate from a cognitive layer to offer a model repository for networks, allowing the automatic addition, deletion and evolution of models. Finally, with fewer agents, the chances of conflicting solutions diminish, and CL's procedures to evaluate and select a solution can be simplified.

### BRIEF DESCRIPTION OF THE DRAWINGS

Some of the embodiments contemplated herein will now be described more fully with reference to the accompanying drawings, in which:

FIG. 1 shows a management node according to various embodiments of the techniques described herein and a telecommunication network having an OSS;

FIGS. 2(a)-(e) shows agent information for five exemplary agents;

FIG. 3 is a flow chart illustrating a general method for reducing a number of agents in a cognitive layer according to various embodiments;

FIG. 4 is a flow chart illustrating a more specific method for reducing a number of agents in a cognitive layer according to various embodiments;

FIG. 5 shows a pair of the exemplary agents considered to have a full match;

FIG. 6 shows another pair of the exemplary agents considered to have a full match;

FIG. 7 shows another pair of the exemplary agents considered to be incompatible with each other;

FIG. 8 shows another pair of the exemplary agents considered to have a partial match;

FIG. 9 is a flow chart illustrating a method of analysing data distributions according to various embodiments;

FIGS. 10(a)-(d) illustrate different outcomes of the method in FIG. 9;

FIG. 11 is a flow chart illustrating an alternative method of analysing data distributions according to various embodiments;

FIG. 12 shows a new agent formed from two of the exemplary agents; and

FIG. 13 is a block diagram of a management node according to various embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Briefly the techniques described herein propose a solution to reduce the number of agents in a cognitive layer that can solve similar problems. The cognitive layer comprises a plurality of agents. Agents are computational entities able to realize a specific goal through the execution of different techniques. For instance, agents can realize an estimation task wherein an agent can estimate one parameter or variable's value based on values of other parameters or values. Also, agents may be responsible for decision-making, whereby the agent must choose the correct setting to achieve their goal, or agents can be just an actuation interface between the CL and some node application programming interface (API). The agents in the cognitive layer are provided to solve problems with a system, such as a telecommunication network (for example a problem such as achieving appropriate frequency band usage, improving network reliability in a part of the telecommunication network, or more generally adjusting or optimising an operational parameter of the telecommunication network). However, it will be appreciated that a cognitive layer can be applied or used in a number of different types of systems, including distributed systems such as distributed computational networks. The number of agents in a cognitive layer can be reduced by identifying agents that have a high degree of similarity assessed based on the agents' descriptions, and determining whether agents can be combined or replaced using techniques such as federated averaging or transfer learning.

Thus, similar agents can be identified by comparing their descriptions, for example determining if agents A and B share the same model type (ML or not), and/or determining if the input and output meta-data of both models is compatible. The data distributions observed by the similar agents can be compared to determine a composition strategy that is used to combine and/or replace the similar agents. In particular, the best strategy to combine the agents depends on the data distributions of the similar agents. In some cases federated averaging of their models would suffice, but in other cases transfer learning, or even retraining, is required. Actions to remove the deprecated agents can also be performed, thus reducing the total amount of agents, while better ones are created.

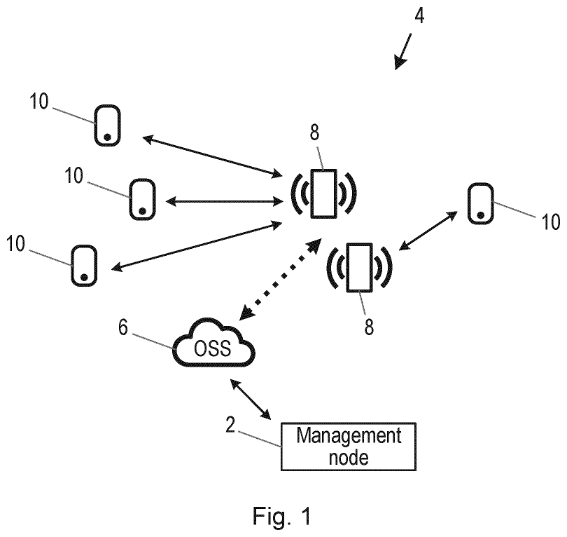

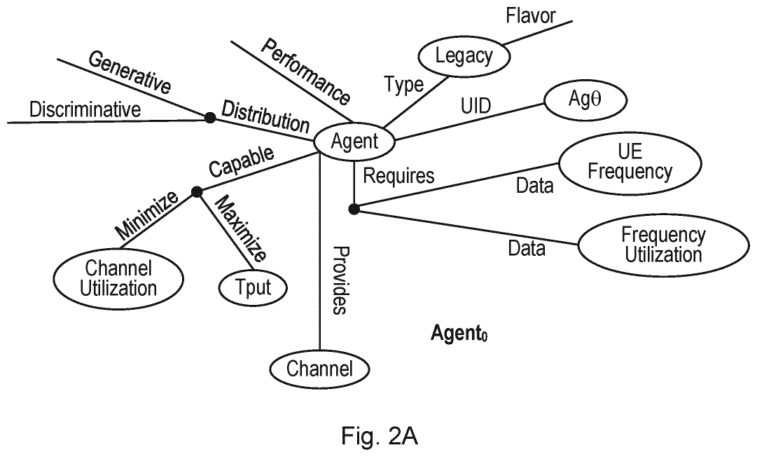

The techniques disclosed herein are described with reference to a service assurance use case, for example in a telecommunication network scenario similar to that shown in FIG. 1. However, as noted above, it will be appreciated that the techniques are not limited to this use case, and they can be applied to any other type of system, complex system or distributed system.

FIG. 1 shows a management node 2 according to various embodiments of the techniques described herein and a telecommunication network 4. The telecommunication network 4 comprises an Operations Support System (OSS) 6 that brings together machine reasoning and ML algorithms to ease the management of the telecommunication network 4. The OSS 6 comprises a cognitive layer (CL) comprising a plurality of agents. In the discussion of the various embodiments herein, the terms OSS 6 and cognitive layer are used interchangeably. The management node 2 can be a part of the telecommunication network 4, part of the OSS 6, or separate from the telecommunication network 4. In either case, the management node 2 is able to interact with the OSS 6 and/or the plurality of agents implemented by the OSS 6.

As noted above, the agents are computational entities that can contain AI models, rule-based policies and/or implement interfaces. Agents are designed to observe and actuate on complex systems. Individual agents offer their capabilities while the CL coordinates a problem-solving task. Agents' interfaces, roles, and capabilities are described and registered in the CL's knowledge base. Agents can assume roles of predictors, decision-makers, observers and/or actuators.

The telecommunication network 4 is otherwise conventional, and comprises, for example, one or more network elements 8 that enable communications via an air interface with one or more wireless devices 10. The telecommunication network 4 may include a radio communications network, such as a New Radio (NR) network. Alternatively or in addition, the telecommunication network 4 may also use technology according to any of Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), Ultra Mobile Broadband (UMB) or GSM, or any other similar network or system. The telecommunication network 4 may also or alternatively be an Ultra Dense Network, UDN, which, for example, may transmit on millimetre-waves (mmW).

A network node 8 serves at least one cell. A network node 8 may correspond to any type of network node or radio network node capable of communicating with a wireless device 10 and/or with another network node 8. The network nodes 8 can be any of a radio base station, gNB, eNB, eNodeB, a Home Node B, a Home eNode B, femto Base Station (BS), pico BS, etc. Further examples of a network node 8 include repeater, base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), core network node (e.g. MSC, MME, etc.), O&M, OSS, SON, positioning node (e.g. E-SMLC), MDT, etc.

The wireless devices 10 is located within a cell. Wireless devices 10 are configured to communicate within the telecommunication network 4 via the network nodes 8 over radio links served by the network nodes 8. A wireless device 10 can be any type of wireless device or user equipment (UE) communicating with a network node 8 and/or with another wireless device 10 in a cellular, mobile or radio communication network or system. Examples of such wireless devices are mobile phones, cellular phones, Personal Digital Assistants (PDAs), smart phones, tablets, sensors equipped with a UE, Laptop Mounted Equipment (LME) (e.g. USB), Laptop Embedded Equipments (LEEs), Machine Type Communication (MTC) devices, or Machine to Machine (M2M) device, Customer Premises Equipment (CPE), target device, device-to-device (D2D) wireless device, wireless device capable of machine to machine (M2M) communication, etc.

When a service is provided to a UE 10 via the telecommunication network 4 (e.g. a data connection, a voice call, etc.), an OSS data collection pipe can collect data relating to the UE 10, the service, etc., and make this data available to any agent in the cognitive layer in the OSS 6.

The techniques described herein make use of agent information (also referred to herein as ‘agent descriptions’) that describe or define various aspects of the agents. This agent information is known to the CL (OSS 6). The agent information can be defined in many different forms, but for the purposes of describing the techniques presented herein, it is assumed that agent information comprises at least the types of content described below.

Thus, the agent information indicates:
one or more types of input data required by a model implemented by the agent;
one or more parameters of the system that are to be improved by the agent;
one or more types of output data provided by the model implemented by the agent; and
a data distribution for the agent.

The one or more types of input data required by the model implemented by the agent refers to the meta data from the model input, i.e. what types of data does the model need to receive as an input in order to provide a suitable output. The types of input data are also referred to herein as being the ‘Requires’ part or field of the agent information. Each input data type is also referred to as a component of the ‘Requires’ field.

The one or more parameters of the system that are to be improved by the agent indicates the parameter(s) or key performance indicators (KPIs) that the model aims to improve. Put another way, applying the output of the model/agent to the system (e.g. telecommunication network 4) affects the one or more parameters in the system. The one or more parameters improved by the agent are also referred to herein as being the ‘Capable’ part or field of the agent information. Each parameter of the one or more parameters is also referred to as a component of the ‘Capable’ field.

The one or more types of output data provided by the model implemented by the agent refers to the meta data from the model output, i.e. what types of data does the model provide as output. The types of output data are also referred to herein as being the ‘Provides’ part or field of the agent information. Each output data type is also referred to as a component of the ‘Provides’ field.

The data distribution for the agent is a statistical representation of input data and/or output data that was used during training and/or in inference phases by the agent. In some embodiments, generative and/or discriminative models can be used to represent data distributions. Another option is to use an autoencoder (e.g. a variational autoencoder (VAE)) model to describe the data distribution.

In some embodiments, the agent information can include one or more other types of information, including any of:
a type of agent;
a unique identifier (UID) for the agent; and
performance information (‘Performance’) for the agent.

The type of agent indicates if the agent is a ML implementation or not. The type of agent is also referred to herein as being the ‘Type’ part or field of the agent information.

The performance information for the agent indicates the historical performance for the agent/model, for example in the form of a performance score. An agent's performance is any metric used to evaluate if the agents' output matches observed variables (e.g., accuracy, recall, precision, area under the curve (AUC)) or a metric used to evaluate the improvement caused by the agents' output when applied to the telecommunication network (e.g. a cost reduction, an improvement ratio in QoE, . . . ). The performance information is also referred to herein as being the ‘Performance’ part or field of the agent information.

Consider, for example, a ‘day 0’ case, e.g. before any cognitive layer is in place for the telecommunication network 4. In this day 0 case, legacy software (e.g. referred to as Agent0) is monitoring a given network parameter of the telecommunication network 4 and provides an output to assure a particular service level is delivered to a wireless device 10. For instance, this legacy software can be a simple rule-based agent that observes the variable “frequency usage”. If the agent observes that the frequency usage is above some threshold, then the software returns a less utilised frequency that the wireless device 10 could use. If the frequency returned is applied to the wireless device 10, it usually improves the channel utilisation and the throughput.

On ‘day 1’, the OSS 6 starts to use a cognitive layer (CL), and therefore the agents need to have descriptions (agent information) that can be used by a reasoning mechanism in the CL 6 to select an appropriate agent or agents to solve a particular problem or issue. As mentioned, the reasoning mechanism in the CL 6 uses the agent information to find suitable agents to fulfil a goal. The ‘legacy agent’ in place from day 0 thus requires agent information in order to work with the cognitive layer 6.

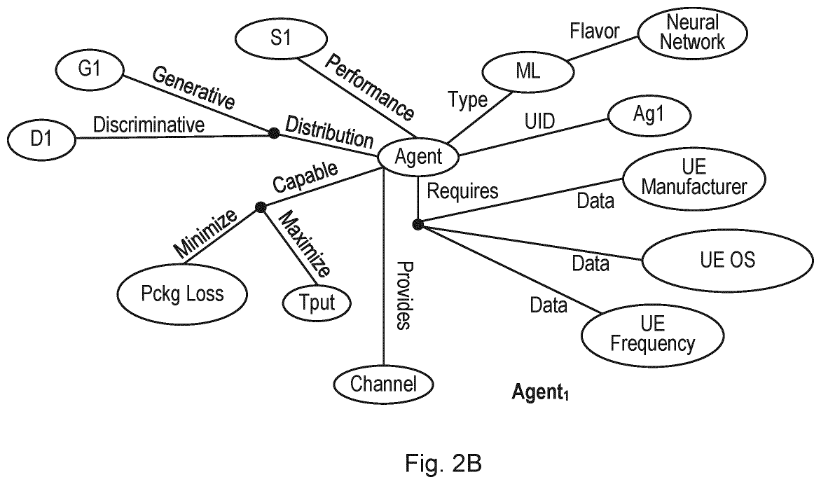

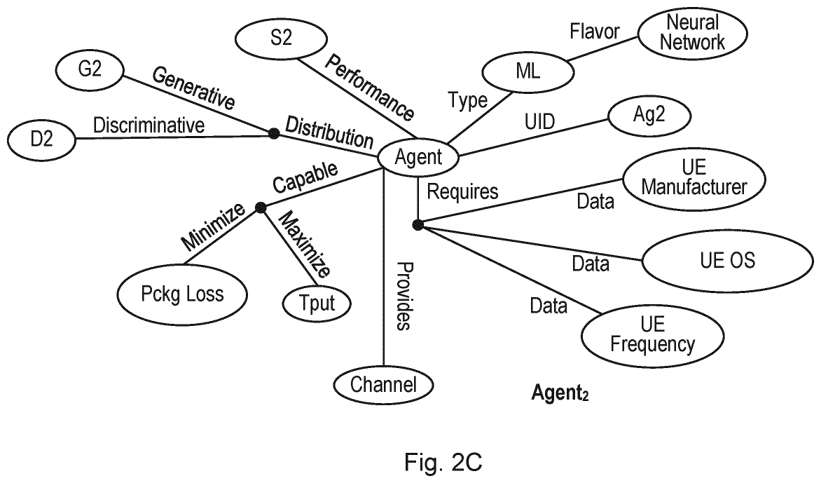

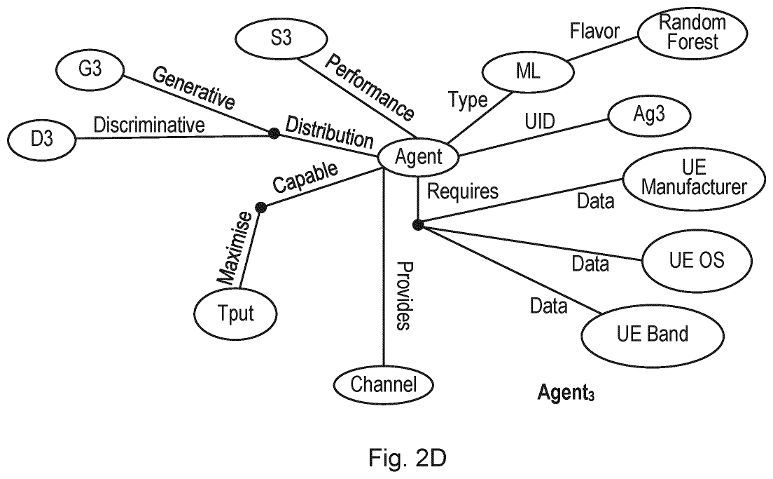

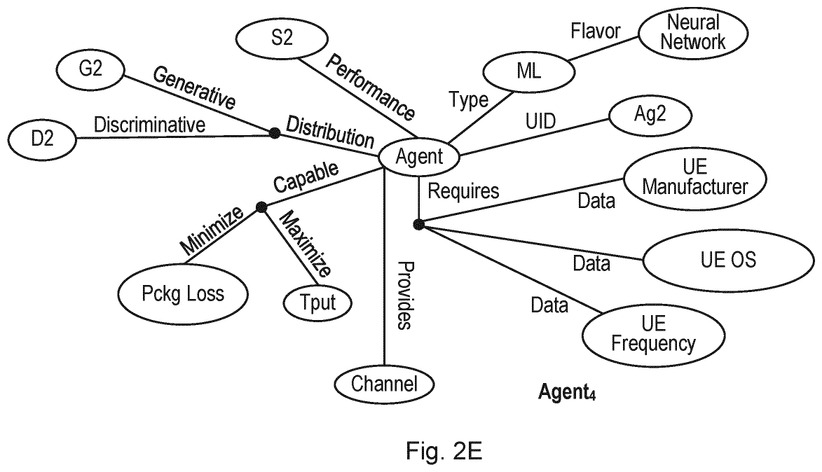

Exemplary agent information for legacy Agentₐ is shown in a graphical form in FIG. 2(a). Thus, Agent₀ ‘requires’ UE frequency and frequency utilisation as inputs, Agent₀ ‘provides’ a channel to use as an output, and Agent₀ is capable of maximising throughput (Tput) and minimising channel utilisation. Agent₀ also has a ‘legacy’ Type and a UID ‘Ag0’.

While the CL 6 just includes Agent₀, a goal can be set to improve the quality of experience (QoE) for a wireless device 10. Through its reasoning mechanism, the cognitive layer 6 decides that throughput needs to be improved and seeks agents capable of proposing actions that may improve it. When the cognitive layer 6 searches for an agent to improve throughput, it looks for a match to throughput in the descriptor/field “Capable” for its agents. As at this stage the cognitive layer 6 only has Agent₀ with the capability to improve throughput, the selection and decision for the best proposal is quickly made.

At the day 1 stage, legacy agents, such as Agent₀, may lack information in the Distribution field in the agent information, reflecting the absence of generative and discriminative models for the data distribution. Moreover, Agent₀ also lacks information in the Performance field. To fill these fields, i.e. to determine the information for these fields, the cognitive layer 6 can start to store data representing the data distribution (e.g. a data distribution representing the distribution of the input data and/or distribution of the output data) and starts to determine and store a performance metric for this agent. Once sufficient input/output information is obtained, the CL 6 can trigger the training of generative and discriminative models using obtained information and fill in all the remaining fields in the agent information.

Subsequently (‘day 2’), four new agents are added to the CL 6. These agents may also be able to suggest a new channel and they may also be able to improve throughput. These agents are labelled Agent₁, Agent₂, Agent₃ and Agent₄. The agent information for each of these agents is shown in FIGS. 2(b)-2(e) respectively. Agent₁ to Agent₄ are all based on machine learning (ML) techniques. The agent information for these agents already include information for their data distributions and performance.

With five agents now able to improve channel utilisation, the cognitive layer 6 needs to call all those agents when a task for channel optimisation arrives. While the use of multiple agents increases the chances for a better performance improvement, it also increases complexity and uses more resources, given that all agents must be called to propose a new action to improve throughput and the CL 6 has to decide each action to select. To cope with the complexity that grows with the number of agents, a method to reduce the number of agents in the CL 6 where the agents have similar capabilities is desirable. The management node 2 is able to perform this method on behalf of the cognitive layer 6.

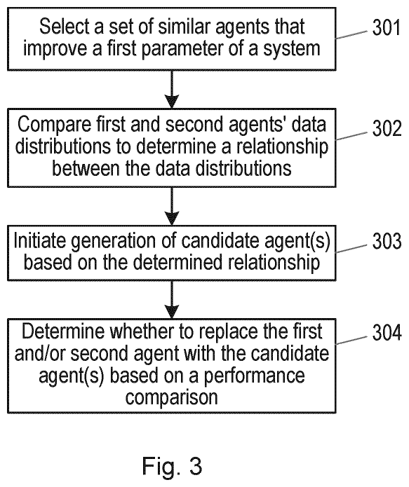

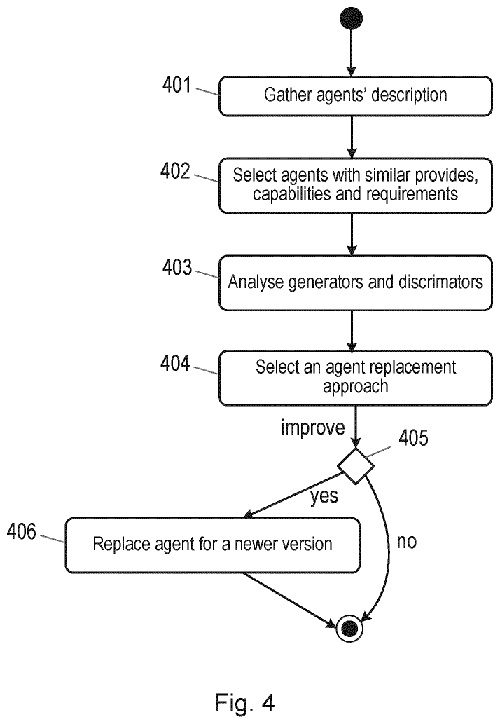

The flow chart in FIG. 3 illustrates a general method for reducing a number of agents in a cognitive layer 6 according to various embodiments that can be performed by the management node 2. The flow chart in FIG. 4 illustrates a more specific method for reducing a number of agents in a cognitive layer 6 according to various embodiments that can be performed by the management node 2. Both methods/flow charts are referenced in the following description.

The first step (step 401 in FIG. 4) is to gather the agent information for each of the agents in the CL 6. Once the management node 2 has the agent information, the method passes to step 301 in FIG. 3/step 402 in FIG. 4 in which the management node 2 evaluates the agent information to select agents that have similar requirements, capabilities and provides information. That is, in step 301/402, the management node 2 aims to select a set of agents from the available plurality of agents that each improve a first parameter of the system 4 (e.g. throughput). The selected agents are those having similarities or matches in the one or more types of input data (the ‘Requires’ information), the one or more types of parameters of the system improved by the agent (the ‘Capable’ information), and the one or more types of output data (the ‘Provides’ information).

The agents can be selected by evaluating similarities or matches using semantic analysis of the information in the Requires, Capable and Provides fields in the agent information. In some embodiments, two agents can be selected for the set of selected agents where there is at least a partial match between the required input data (‘Requires’), at least a partial match between the provided output data (‘Provides’), and at least a partial match between the parameters of the system improved by the two agents (‘Capable’). In embodiments of step 301/402, the management node 2 can consult a knowledge base for more information about each field in order to identify similarities or matches in each of the Requires, Capable and Provides fields. This knowledge base can be composed of ontologies that allow reasoning-based mechanism(s) to identify that two different pieces of information refer to the same concept. The knowledge base can also include word embeddings of each field to allow a semantical search to be performed. Suitable techniques for evaluating similarities between information in the relevant fields can include reasoning techniques, vector representation, or exact string matching.

Regardless of the method used to identify agents with similar information, it may be the case that information in a particular field for an agent matches the information in that field for another agent fully or partially. A full match means that each component or type in a particular field for agent “A” can be matched against each component or type of the same field for agent “B”. For example, agent “A” may Require two types or components of input data, Input1 and Input2, and agent “B” may Require the same two types or components of input data, Input1 and Input2, and so there is a full match. On the other hand, there may be a partial match meaning that not all components or types for a field for agent “A” match all of the components or types for the same field for agent “B”. For example, agent “C” may Require two types or components of input data, Input1 and Input2, and agent “D” may only Require Input1, and so there is a partial match.

According to these definitions of a full match and partial match, the following principles can be applied when selecting agents in step 301/402. When there is a full match for the Requires information and a partial or full match for the Capable and Provides information, the agents can be immediately selected in step 301/402. Otherwise, when a partial match for the Requires information occurs, and there is a partial or full match for the Capable and Provides information, more data regarding the union of the Requires components or types needs to be collected and new components for the data distribution field must be obtained. This can enable a full match to be achieved between the components in the Requires field.

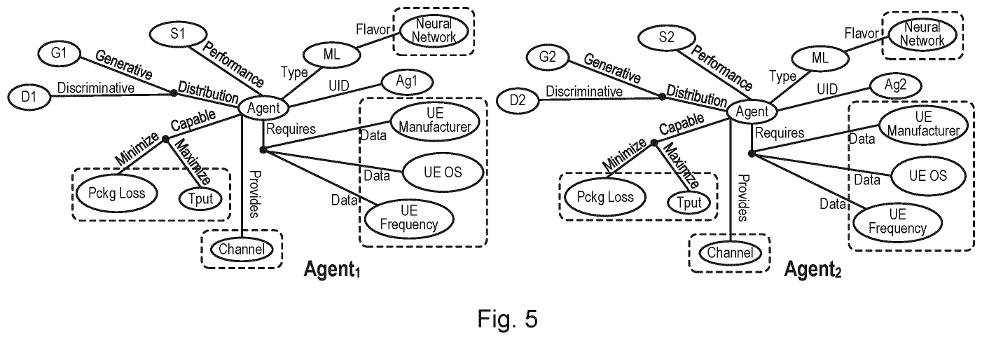

Three examples of the agent selection step are discussed below with reference to FIGS. 5 to 8.

FIG. 5 shows a pair of the agents considered to have a full match. In particular, FIG. 5 shows Agent₁ and Agent₂. Although Agent₁ and Agent₂ are different as they have different components in the Generative and Discriminative data distributions, and different UIDs, they match since both have the same components (full match) in the Requires, Provides, and Capable fields. These agents also match in the Type field (ML). The fields where there are matches in the agent information are indicated by dashed boxes in FIG. 5.

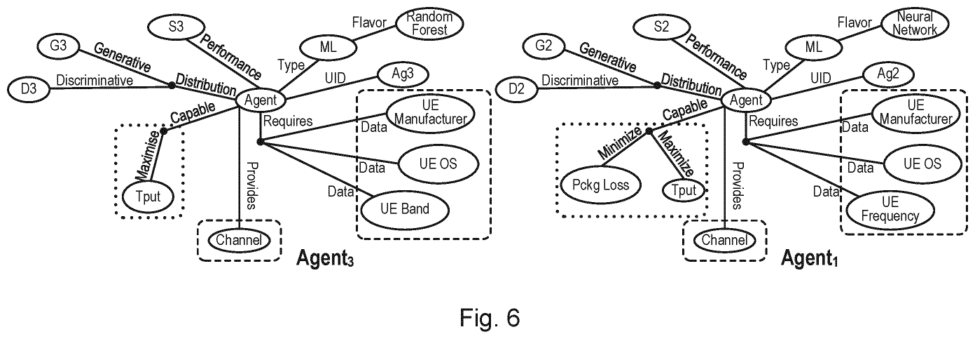

FIG. 6 shows another pair of the exemplary agents considered to have a full match, although in this case additional information is required in order to determine the full match. FIG. 6 shows Agent₃ and Agent₁. Agent₃ and Agent₁ are different as they have different UIDs, data distributions, Type, Capable and Requires fields. However, they also represent a match since there is a full match for the components in the Provide field, as indicated by the dashed boxes, and there is a partial match for the Capable field (i.e. both are capable of improving throughput), as indicated by the dotted boxes. Although initially different, the Requires field is a full match (indicated by the dashed boxes) when additional information is obtained for the components ‘UE Frequency’ (Agent₁) and ‘UE Band’ (Agent₃). For instance, this additional information can be represented by the cosine distance between the embeddings (definitions) of ‘UE Band’ and ‘UE Frequency’ close to one

$$( cos θ = \frac{U {E}_{FREQUENCY} U {E}_{BAND}}{‖ {UE}_{FREQUENCY} ‖ ‖ {UE}_{BAND} ‖} \approx 1 ) ,$$

which depicts the similarity between the components.

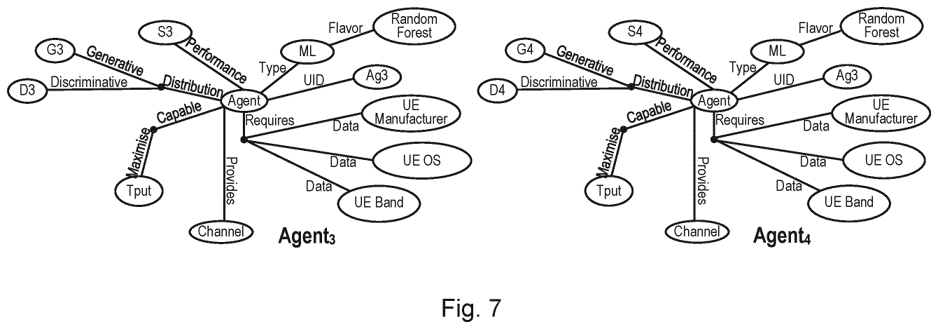

FIG. 7 shows another pair of the exemplary agents considered to be incompatible with each other. FIG. 7 shows Agent₃ and Agent₄. Agent₃ and Agent₄ do not represent a match as their Requires fields do not have any similar or matching components.

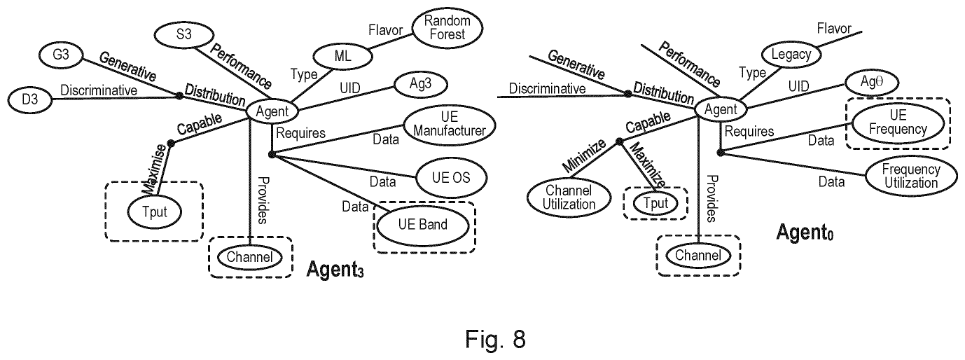

FIG. 8 shows another pair of the exemplary agents considered to have a partial match. FIG. 8 shows Agent₃ and Agent₀. Agent₀ and Agent₃ do not represent a match, given there is a partial match for the Requires information, as indicated by the dashed boxes. However due to a match among the Capable and Provides information, and the partial match between the Requires information, these agents are selected for a new data collection and for training the generative and discriminative models of their data distributions. Therefore, for a period of time the data features “UE Frequency”, “Frequency Utilization”, “UE OS”, and “UE Manufacturer” from both agents are collected and used to train new discriminative and generative models for the respective agents.

Following the examples above, all of the agents are capable of proposing an action that improves the throughput. However, the incompatibility between the Requires field for Agent₄ and all other agents prevents Agent₄ from being selected in step 301/402. Thus, in step 301/402, Agent₀, Agent₁, Agent₂ and Agent₃ are selected as similar agents.

Next, in step 302, the data distributions for two agents in the selected set of similar agents are compared to determine or identify a relationship between the data distributions, as described further below. As noted in step 403 of FIG. 4, step 302 can comprise analysing or comparing data distributions for each of the two agents. In some embodiments the analysis or comparison of the data distributions is performed using variational auto-encoders, and in other embodiments the analysis or comparison of the data distributions uses a pair of generative and discriminative neural networks.

The output of step 302/403 is an indication of whether the data distributions for the two agents evaluated in step 302/403 are identical or substantially identical, whether the data distribution for one of the evaluated agents is contained within the data distribution for the other one of the evaluated agents, or whether the data distributions for the evaluated agents are disjoint.

The generative and discriminative neural networks are trained using the same data fed into the agents during training and/or in inference phases (i.e. while the agents are deployed and in use). While a generative neural network (‘generator’) learns to map noisy inputs to artificial data, a discriminative neural network (‘discriminator’) learns to distinguish such data from real data points. Both types of neural networks can be trained simultaneously as adversaries (Generative Adversarial Networks, GAN). The availability of discriminators and generators makes it possible to identify relationships among data distributions, which is a useful step for identifying redundant agents in the CL 6. Thus, in some embodiments, step 302/403 can comprise comparing the generator and discriminator neural networks that represent the data distribution for one of the two agents to the generator and discriminator neural networks that represent the data distribution for the other one of the two agents to determine the relationship between the data distributions. In some embodiments, autoencoders can be used to compare the data distributions.

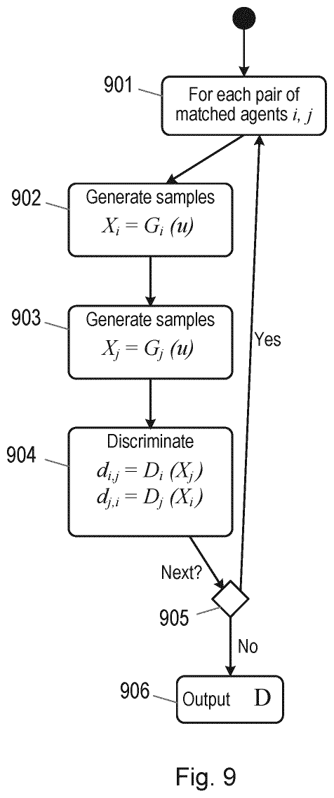

The flow chart in FIG. 9 illustrates how data distributions can be analysed in step 302/403 according to various embodiments. Steps 901-904 are performed for each pair of agents in the selected set of agents determined in step 301/402. Thus, starting with two of the agents, e.g. Agentᵢ and Agentⱼ, in step 902 samples Xᵢ are generated for Agentᵢ using the generative neural network for Agentᵢ (Gᵢ), and in step 903 samples Xⱼ are generated for Agentⱼ using the generative neural network for Agentⱼ (Gⱼ).

Next in step 904, the discriminative neural network Dᵢ for Agentᵢ is used to determine the data distribution distance d_{i,j} based on the samples Xⱼ determined in step 902, and the discriminative neural network Dⱼ for Agentⱼ is used to determine the data distribution distance d_{j,i} based on the samples Xᵢ determined in step 903.

In step 905 it is checked whether the data distributions for all possible pairs of agents in the selected set have been evaluated, and if so, in step 906 a matrix D is output whose values provide information about the relationship between the data distributions for all possible pairs of selected agents.

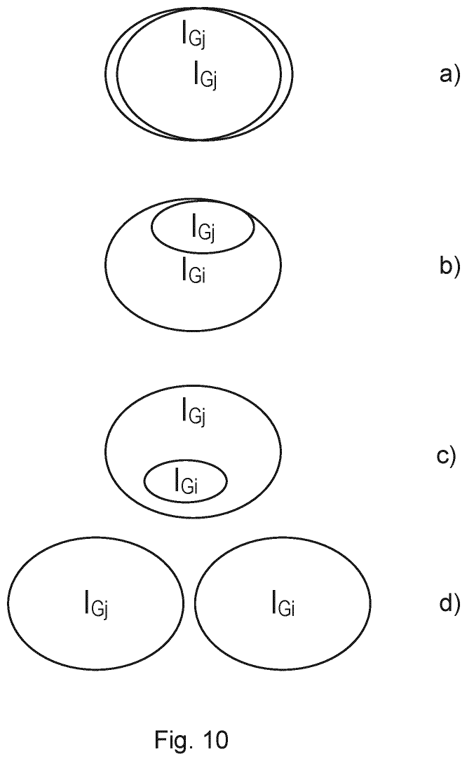

In some embodiments, the output of step 302/403 can be, or include, an indication of a degree of overlap between the data distributions. FIGS. 10(a)-(d) illustrate different degrees of overlap between data distributions for two agents, denoted Agentᵢ and Agentⱼ, based on the output of the method in FIG. 9.

If d_{i,j} and d_{j,i} are small, then the Gᵢ and Gⱼ images are identically, or substantially identically, distributed, as shown in FIG. 10(a).

If d_{i,j} is small and d_{j,i} is large, then the Gᵢ image contains the Gⱼ image, as shown in FIG. 10(b). That is, the data distribution for Agentⱼ is contained within the data distribution for Agentᵢ.

If d_{i,j} is large and d_{j,i} is small, then the Gᵢ image is contained by the Gⱼ image, as shown in FIG. 10(c). That is, the data distribution for Agentⱼ contains the data distribution for Agentᵢ.

If d_{i,j} and d_{j,i} are large, then the Gᵢ and Gⱼ images are disjoint, or non-overlapping, as shown in FIG. 10(d).

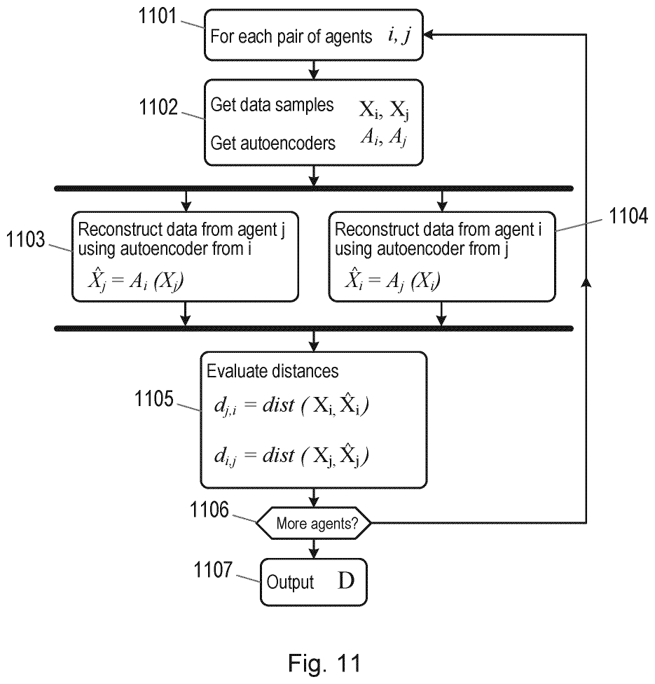

In some embodiments of step 302/403, autoencoders can be used to compare the data distributions. Thus, a procedure similar to that shown in FIG. 9 can be performed using autoencoders to evaluate the relationship between the data distributions. The autoencoder embodiment is shown in FIG. 11. This option requires data points Xᵢ and Xⱼ to be exchanged between the agents, thus imposing that agents have full access to both data sources, which can lead to privacy concerns.

Thus, steps 1101-1107 of FIG. 11 are performed for each pair of agents in the selected set of agents determined in step 301/402. Thus, starting with two of the agents, e.g. Agentᵢ and Agentⱼ, in step 1102 samples Xᵢ are collected from Agentᵢ, samples Xⱼ are collected from Agentⱼ.

Next in step 1103, the data distribution for Agentⱼ is reconstructed using the autoencoder Aᵢ. This is represented by \hat{X}ⱼ=Aᵢ(Xⱼ).

In step 1104, the data distribution for Agentᵢ is reconstructed using the autoencoder Aⱼ. This is represented by \hat{X}ᵢ=Aⱼ(Xᵢ).

In step 1105 the data distribution distances d_{i,j} and d_{i,j} are determined as follows:

d_{j,i}=dist(Xᵢ,\hat{X}ᵢ) (1)

d_{i,j}=dist(Xⱼ,\hat{X}ⱼ) (2)

In step 1106 it is checked whether the data distributions for all possible pairs of agents in the selected set have been evaluated, and if so, in step 1107 a matrix D is output whose values provide information about the relationship between the data distributions for all possible pairs of selected agents.

Next, in step 303/404, the management node 2 initiates the generation of one or more candidate agents based on the relationship determined in step 302/403. In some embodiments, step 303/404 comprises the management node 2 requesting the generation of one or more candidate agents from another entity, such as another node in the system that is responsible for, or capable of, generating candidate agents. In alternative embodiments, step 303/404 comprises the management node 2 itself generating one or more candidate agents based on the relationship determined in step 302/403. In either embodiment, step 303/404 can comprise the management node 2 determining an appropriate approach for generating the candidate agent(s) based on the determined relationship between the data distributions. Where the management node 2 outsources the generation of the candidate agent(s) to another entity, the management node 2 can indicate the appropriate approach to that other entity. Alternatively, where the management node 2 outsources the generation of the candidate agent(s) to another entity, the management node 2 can communicate information on the relationship between the data distributions, and the entity can determine the appropriate approach for generating the candidate agent(s). In the following description, it is assumed that the management node 2 generates the candidate agents, but a separate entity can perform similar operations to generate the candidate agents.

Thus, for the two agents evaluated in step 302/403, one or more candidate agents are generated or determined, depending on the relationship between the data distributions of the agents. Reference is again made to two agents, Agentᵢ and Agentⱼ.

If the data distribution relationship is as shown in FIG. 10(a) (i.e. the data distributions are identical or substantially identical), then it is possible for both of the two agents to be replaced by a new agent. In this case a candidate agent can be generated as a combination of Agentᵢ and Agentⱼ using federated averaging learning. For example a federated learning model composition with average strategy (FL_AVG) can be used to generate a candidate model, if the two agents have the same ‘flavor’ descriptor (e.g. both neural networks). In an alternative approach, a first candidate agent can be generated by retraining Agentᵢ using the data distribution for Agentᵢ and the data distribution for Agentⱼ, and determining a second candidate agent by retraining Agentⱼ using the data distribution for Agentᵢ and the data distribution for Agentⱼ. Thus, this approach retrains the models of Agentᵢ and Agentⱼ with data from i and j (which generates Agentᵢ^{i,j} and Agentⱼ^{i,j}, respectively) and does not impose any constraint on an agent's ‘flavor’ descriptor.

If the data distribution relationship is as shown in FIG. 10(b) (i.e. the data distributions for Agentᵢ contains the data distribution for Agentⱼ), then it is possible to replace Agentⱼ with another agent. In this case, there are at least three options for generating a candidate agent to replace Agentⱼ.

A first option is to define Agentᵢ as a candidate to replace Agentⱼ. That is, Agentⱼ can be directly replaced by Agentᵢ.

A second option is to determine a candidate agent by retraining the model for Agentᵢ using the data distribution from Agentᵢ and the data distribution from Agentⱼ. That is, this option involves retraining the Agentᵢ model with data from i and j (which generates Agentᵢ^{i,j}).

A third option is to determine a candidate agent by performing transfer learning for Agentᵢ using the data distribution from Agentⱼ. This generates Agentᵢ^{Tj}.

If the data distribution relationship is as shown in FIG. 10(c) (i.e. the data distributions for Agentⱼ contains the data distribution for Agentᵢ), then it is possible to replace Agentᵢ with another agent. In this case, there are at least three options for generating a candidate agent to replace Agentᵢ.

A first option is to define Agentⱼ as a candidate to replace Agentᵢ. That is, Agentᵢ can be directly replaced by Agentⱼ.

A second option is to determine a candidate agent by retraining the model for Agentⱼ using the data distribution from Agentⱼ and the data distribution from Agentᵢ. That is, this option involves retraining the Agentⱼ model with data from i and j (which generates Agentⱼ^{i,j}).

A third option is to determine a candidate agent by performing transfer learning for Agent using the data distribution from Agentᵢ. This generates Agentⱼ^{Tj}.

If the data distribution relationship is as shown in FIG. 10(d) (i.e. the data distributions for Agentᵢ and Agentⱼ are disjoint), then both agents can be replaced by a newly generated agent. In this case a candidate agent can be generated by training a new agent using the data distribution from Agentᵢ and the data distribution from Agentⱼ.

Once one or more candidate agents have been generated, the performance of these candidate agent(s) needs to be compared with the performance of the existing agent(s) (i.e. the first agent and second agent) so that a decision can be taken as to whether the candidate agent(s) should replace one or both of the existing agents.

In some embodiments, the performance of the one or more candidate agents can be evaluated by applying data for the first agent (e.g. Agentᵢ) to the one or more candidate agents, and applying the data for the second agent (e.g. Agentⱼ) to the one or more candidate agents. This provides an indication of the performance of the one or more candidate agents. The data used to evaluate the performance of a candidate agent may be artificially generated by the generative models in the ‘distribution’ descriptors in the agent information, or the data may be the actual data, depending on the implementation. In some embodiments, the performance analysis of the candidate agent(s) against the existing agent(s) may not occur as soon as the candidate agent(s) are generated, and instead, the candidate agent(s) may be subject to a grace period in which the candidate agent(s) are used in the CL 6 to enable data to be collected for the candidate agent(s), and enable a more effective comparison of the candidate agent(s) and the existing agent(s).

In step 304/405 the determined performance of the one or more candidate agents is compared to the performance of the first agent and/or second agent (as appropriate, depending on which of the first agent and the second agent could be replaced according to the result of the relationship between the data distributions). The result of this comparison indicates whether one or both of the first agent and the second agent (as appropriate) should be replaced with the one or more candidate agents.

If it is determined that an existing agent should be replaced, then in step 406 the existing agent(s) is(are) removed from the plurality of agents in the CL 6 and the plurality of agents is updated to include the relevant candidate agent.

Subsequently, when the first parameter of the system is to be improved, input data is provided to the agents in the updated plurality of agents that can improve the first parameter, and output data is received from those agents.

In general, in step 304/405 a candidate agent can be selected as a replacement for one or both of the existing agents if it has a better performance than the existing agent(s) for the data distributions. If no candidate agent provides improved performance for any data distribution, then no existing agents are replaced. However, in a case where both existing agents are candidates for replacement, then if a first candidate agent has a better performance for one data distribution and a second candidate agent has a better performance for a second data distribution, the decision for replacement can be escalated and considered further. Examples of step 304/405 are provided below.

As noted above, steps 302-304/403-405 are performed for a pair of agents in the set of agents selected in step 301/402. In some embodiments, steps 302-304/403-405 are repeated for each pair of agents in the selected set. In further embodiments, steps 302-304/403-405 are repeated for all possible pairs of agents in the selected set of similar agents. In further embodiments, after updating the plurality of agents to include any new agents and removing any of the existing agents, the method in FIGS. 3 and 4 can be repeated for the updated plurality of agents to determine if any other agents can be removed or replaced. By repeating the method in this way, the plurality of agents can be refined and multiple agents removed. This is illustrated by the series of following examples.

This first example relates to a candidate agent being selected as a replacement for an existing agent as it has a better performance than the existing agent(s). Consider Agent₀ and Agent₁ as shown in FIGS. 2(a) and 2(b). The data distributions of Agent₀ and Agent₁ are identically distributed, hence in steps 302/403 these agents have a data distribution relationship as shown in FIG. 10(a) (i.e. the data distributions are identical or substantially identical). Therefore, when generating candidate agent(s), there are two alternatives to compose those agents, as described above with reference to FIG. 10(a). The first option is to compose a candidate agent using a federated averaging learning strategy. To use this option, the flavors of the agents, e.g., neural networks, random forest, gradient boosting, should be the same. It will be noted that this option does not apply to Agent₀ and Agent₁ as they have different flavor descriptors, ‘None’ and ‘Neural Network’. Therefore, only the second option can be used to generate a candidate agent, and two new models are obtained, a first candidate agent, denoted Agent₀^{0,1}, which results from applying Agent₀ to the union of the data distributions of Agent₀ and Agent₁, and a second candidate agent, denoted Agent₁^{0,1}, which results from applying Agent₁ to the union of the data distributions of Agent₀ and Agent₁.

The performance of these candidate agents can be evaluated using data from Agent₀ and Agent₁ (denoted x₀ and x₁ respectively):

TABLE 1
Performance

| Model/Data | x₀ | x₁ |
|---|---|---|
| Agent₀ | p₀ | p′₀ |
| Agent₁ | p₁ | p′₁ |
| Agent₀^{0, 1} | p₂ | p′₂ |
| Agent₁^{0, 1} | p₃ | p′₃ |

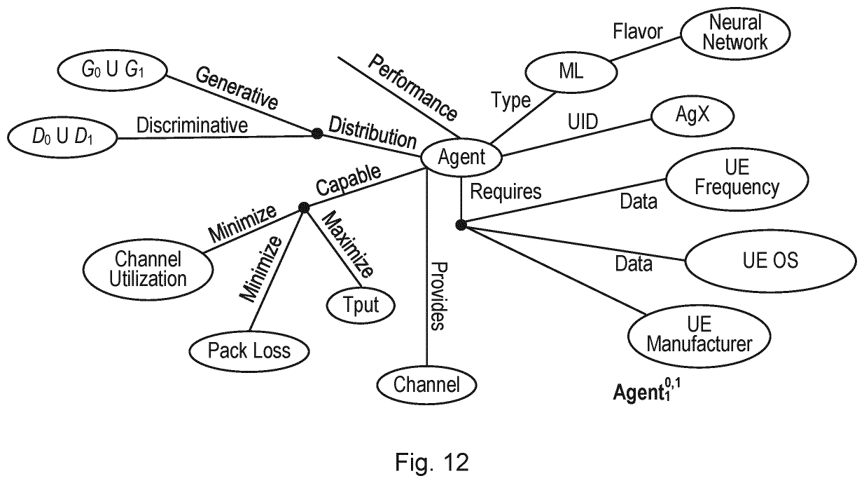

Assuming that the performance values p₃ and p₃′ are the best available, i.e. p₃ p₂≥p₁≥p₀ and p₃′≥p₂′≥p₁′≥p₀′, in this case Agent₀^{0,1} is selected as the replacement agent for Agent₀ and Agent₁. The agent information for the selected new agent, Agent₁^{0,1}, is shown in FIG. 12. The agent information for Agent₁^{0,1} is generated as follows:
‘Distribution’ field: the data distribution used to train the new agent is used to obtain the generative and discriminative models;
‘Requires’ field: the meta-data of the data used as inputs for the new agent, Agent₁^{0,1};
‘Capable’ field: the union of the ‘Capable’ descriptor for both Agent₀ and Agent₁ is used. If there are any ‘similar’ capabilities between the agents, for example as determined in step 301/402, then the descriptor for only one of the similar capabilities is included in the Capable field;
‘Provides’ field: the union of the ‘Provides’ descriptor for Agent₀ and Agent₁ is used. If there are any ‘similar’ ‘provides’ descriptors between the agents, for example as determined in step 301/402, then the descriptor for only one of the similar ‘Provides’ is included in the Provides field;
‘Type’ field: the type of the new agent, the Type can be inherited from one of the two agents, Agent₀ and Agent₁.

This second example continues the first example and relates to a candidate agent being selected as a replacement for an existing agent as it has a better performance than the existing agent(s). In this example consider Agent₁^{0,1} (which has been added to the plurality of agents according to the first example) and Agent₂ as shown in FIG. 12 and FIG. 2(c) respectively. The data distribution of Agent₁^{0,1} contains the data distribution of Agent₂, hence in steps 302/403 these agents are determined to have a data distribution relationship as shown in FIG. 10(b). In this example the third option is used to generate a candidate agent, and in particular a candidate agent, denoted Agent₁^{0.1T2}, is generated by performing transfer learning for Agent₁^{0,1} using the data distribution from Agent₂. Agent₁^{0.1T2} is created by freezing all layers of the neural network of Agent₁^{0.1} except the last two layers, and retraining Agent₁^{0.1} with the data distribution for Agent₂. Also, the second option is used to generate Agent₁^{0,1} by retraining Agent₁^{0,1} using the data distribution from Agent₂ and Agent₁^{0,1}. By the end of the procedure the following evaluation table, Table 2, is obtained:

TABLE 2
Performance

| Model/Data | x_{0, 1} | x₂ |
|---|---|---|
| Agent₁^{0, 1} | p₀ | p′₀ |
| Agent₂ | p₁ | p′₁ |
| Agent₁^{0, 1T2} | p₂ | p′₂ |
| Agent₁^{0, 1, 2} | p₃ | p′₃ |

Assuming that p₂′≥p₃′≥p₁′≥p₀′, the best model for Agent₂ data, x₂, is the newly created transfer learned agent, Agent₁^{0.1T2}. Therefore this agent replaces Agent₂. It should be noted that in this case the number of agents in the plurality of agents remains the same after the update, but the overall performance of the CL 6 is improved as Agent₂ has been replaced with a better performing agent.

This third example also continues on from the second example and relates to a decision on whether to replace an existing agent with a candidate agent being escalated and considered further. In this example consider Agent₁^{0,1} (which has been added to the plurality of agents according to the first example) and Agent₃ as shown in FIG. 12 and FIG. 2(d) respectively. The data distributions of Agent₁^{0,1} and Agent₃ are disjoint, hence in steps 302/403 these agents are determined to have a data distribution relationship as shown in FIG. 10(d). In this example a candidate agent can be generated by training a new agent using the data distribution from Agent₁^{0,1}, and Agent₃. In this example, one new agent is obtained using Neural Network, NewModel_{0,1,3}^{NN}, and a second new agent is trained using Random Forest, NewModel_{0,1,3}^{RF}. By the end of the procedure the following evaluation table, Table 3, is obtained:

TABLE 3
Performance

| Model/Data | x_{0, 1} | x₃ |
|---|---|---|
| Agent₁^{0, 1} | p₀ | p′₀ |
| Agent₃ | p₁ | p′₁ |
| NewModel_{0, 1, 3}^{NN} | p₂ | p′₂ |
| NewModel_{0, 1, 3}^{RF} | p₃ | p′₃ |

Assuming the performance values are as follows: p₃≥p₂≥p₀≥p₁ and p₂′≥p₃′≥p₁′≥p₀, then in this case it is difficult to decide if NewModel_{0,1,3}^{RF} or NewModel_{0,1,3}^{NN} is the best agent to replace Agent₂ and Agent₁^{0,1}. This is due to NewModel_{0,1,3}^{RF} having the best performance for x_{0,1} and NewModel_{0,1,3}^{NN} having the best performance for x₃. In this case, other methods may be used to take the decision for replacement (e.g. these other methods could include Pareto frontier, escalation for a specialist decision, or a greedy strategy to pick the best possible agents). For instance, consider that after an escalation to a specialist, NewModel_{0,1,3}^{RF} is chosen due to its simplicity when compared to NewModel_{0,1,3}^{NN}, and NewModel_{0,1,3}^{RF} replaces Agent₀ and Agent₁^{0,1}.

Thus, by the end of the three examples above, Agent₁^{0,1}, replaced Agent₀ and Agent₁, and Agent₁^{0.1T2} replaced Agent₂, and NewModel_{0,1,3}^{RF} replaced Agent₁^{0,1}, and Agent₃. Thus, four out of the original five agents (Agent₀-Agent₄) have been removed and/or replaced by a better agent(s), thus facilitating the process to provide better proposals to solve a given goal.

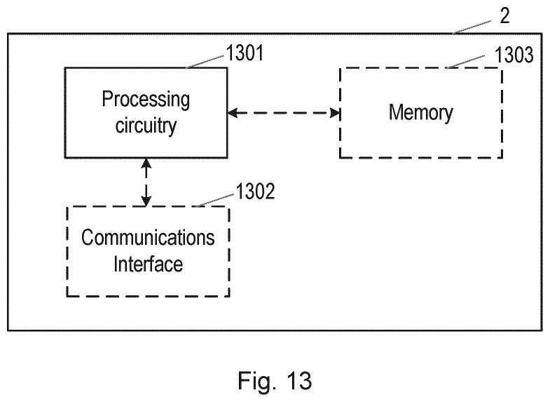

FIG. 13 illustrates management node 2 according to various embodiments that can be used to implement the techniques described herein.

The management node 2 comprises processing circuitry (or logic) 1301. It will be appreciated that the management node 2 may comprise one or more virtual machines running different software and/or processes. The management node 2 may therefore comprise one or more servers, switches and/or storage devices and/or may comprise cloud computing infrastructure that runs the software and/or processes.

The processing circuitry 1301 controls the operation of the management node 2 and can implement the methods described herein in relation to the management node 2. The processing circuitry 1301 can comprise one or more processors, processing units, multi-core processors or modules that are configured or programmed to control the management node 2 in the manner described herein. In particular implementations, the processing circuitry 1301 can comprise a plurality of software and/or hardware modules that are each configured to perform, or are for performing, individual or multiple steps of the method described herein in relation to the management node 2.

In some embodiments, the management node 2 may optionally comprise a communications interface 1302. The communications interface 1302 can be for use in communicating with other nodes, such as other management nodes 2, servers, network nodes in the telecommunication network 4, etc. For example, the communications interface 1302 can be configured to transmit to and/or receive from other nodes requests, acknowledgements, information, data, signals, or similar. The processing circuitry 1301 may be configured to control the communications interface 1302 to transmit to and/or receive from other nodes requests, acknowledgements, information, data, signals, or similar.

Optionally, the management node 2 may comprise a memory 1303. In some embodiments, the memory 1303 can be configured to store program code that can be executed by the processing circuitry 1301 to perform the method described herein in relation to the management node 2. Alternatively or in addition, the memory 1303 can be configured to store any requests, acknowledgements, information, data, signals, or similar that are described herein. The processing circuitry 1301 may be configured to control the memory 1303 to store such information therein.

Therefore there is provided a mechanism that uses semantic knowledge of an agent, together with its performance to decide how and whether to maintain such an agent in a cognitive layer. For instance, this can be used to decide which agents are redundant and can be replaced or removed altogether. The semantic knowledge used relates to types of input data ‘required’ by the model/agent, the problem(s) the model/agent is ‘capable’ of addressing (e.g. optimisation of virtual network function (VNF) placement, congestion control, etc.). Embodiments of the techniques also define the use of complementary agent information describing the data distribution the agent has “seen” after deployment (e.g. generative models created based on data gathered when the agent was active).

The described techniques provide advantages such as the ability for a management node to manage agents in a cognitive layer. Developers and/or model providers are able to manage their own models (e.g. providing important meta-data) and the management node is able to decide if that model has any overlap with existing ones, and when to use, combine and remove these models.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A computer-implemented method performed by a management node for use with a cognitive layer, CL, that is used to improve or manage a system, wherein the CL comprises a plurality of agents, wherein the agents have respective agent information, the respective agent information indicating one or more types of input data required by a model implemented by the agent, one or more parameters of the system that are to be improved by the agent, one or more types of output data provided by the model implemented by the agent and a data distribution for the agent, wherein the method comprises:
(i) selecting a set of similar agents from the plurality of agents that improve a first parameter of the system, wherein similar agents are selected on the basis of similarities or matches in the one or more types of input data, the one or more types of parameters of the system improved by the agent, and the one or more types of output data;
(ii) for a first agent and a second agent in the selected set of similar agents, comparing the data distribution for the first agent to the data distribution for the second agent to determine a relationship between the data distributions;
(iii) initiating generation of one or more candidate agents based on the determined relationship; and
(iv) determining whether to replace one or both of the first agent and the second agent with the one or more candidate agents based on a comparison of a performance of the one or more candidate agents with respect to a performance of the first agent and/or a performance of the second agent.

2.-18. (canceled)

19. A computer program product comprising a non-transitory computer readable medium having computer readable code embodied therein, the computer readable code being configured such that, on execution by a computer or processor, the computer or processor is caused to perform operations in a management node for use with a cognitive layer, CL, that is used to improve or manage a system, wherein the CL comprises a plurality of agents, wherein the agents have respective agent information, the respective agent information indicating one or more types of input data required by a model implemented by the agent, one or more parameters of the system that are to be improved by the agent, one or more types of output data provided by the model implemented by the agent and a data distribution for the agent, the operations in the management node comprising:
(i) selecting a set of similar agents from the plurality of agents that improve a first parameter of the system, wherein similar agents are selected on the basis of similarities or matches in the one or more types of input data, the one or more types of parameters of the system improved by the agent, and the one or more types of output data;
(ii) for a first agent and a second agent in the selected set of similar agents, comparing the data distribution for the first agent to the data distribution for the second agent to determine a relationship between the data distributions;
(iii) initiating generation of one or more candidate agents based on the determined relationship; and
(iv) determining whether to replace one or both of the first agent and the second agent with the one or more candidate agents based on a comparison of a performance of the one or more candidate agents with respect to a performance of the first agent and/or a performance of the second agent.

20. A management node for use with a cognitive layer, CL, that is used to improve or manage a system, wherein the CL comprises a plurality of agents, wherein the agents have respective agent information, the respective agent information indicating one or more types of input data required by a model implemented by the agent, one or more parameters of the system that are to be improved by the agent, one or more types of output data provided by the model implemented by the agent and a data distribution for the agent, wherein the management node is configured to:
(i) select a set of similar agents from the plurality of agents that improve a first parameter of the system, wherein similar agents are selected on the basis of similarities or matches in the one or more types of input data, the one or more types of parameters of the system improved by the agent, and the one or more types of output data;
(ii) for a first agent and a second agent in the selected set of similar agents, compare the data distribution for the first agent to the data distribution for the second agent to determine a relationship between the data distributions;
(iii) initiate generation of one or more candidate agents based on the determined relationship; and
(iv) determine whether to replace one or both of the first agent and the second agent with the one or more candidate agents based on a comparison of a performance of the one or more candidate agents with respect to a performance of the first agent and/or a performance of the second agent.

21. A management node as claimed in claim 20, wherein operation (iv) comprises determining that one or both of the first agent and the second agent should be replaced if the performance of the one or more candidate agents exceeds the performance of the first agent and/or the second agent.

22. A management node as claimed in claim 20, wherein the management node is further configured to:
(v) if it is determined to replace one or both of the first agent and the second agent with the one or more candidate agents, update the plurality of agents by replacing the one or both of the first agent and the second agent in the plurality of agents with the one or more candidate agents in the plurality of agents.

23. A management node as claimed in claim 22, wherein the management node is further configured to:
(vi) when the first parameter of the system is to be improved, provide input data to the agents in the updated plurality of agents that are to improve the first parameter, and receiving output data from the agents in the updated plurality of agents that are to improve the first parameter.

24. A management node as claimed in claim 20, wherein the management node is further configured to:
repeating operations (ii)-(iv) for other pairs of agents in the selected set of similar agents.

25. A management node as claimed in claim 24, wherein operations (ii)-(iv) are repeated for all possible pairs of agents in the selected set of similar agents.

26. A management node as claimed in claim 20, wherein operation (i) comprises evaluating similarities or matches using semantic analysis of the required one or more types of input data, the one or more types of parameters of the system improved by the agent and provided one or more types of output data for the agents.

27. A management node as claimed in claim 20, wherein the management node is further configured to:
(iii-a) compare the performance of the one or more candidate agents with respect to the performance of the first agent and/or the performance of the second agent.

28. A management node as claimed in claim 27, wherein operation (iii-a) comprises:
determining the performance of the one or more candidate agents by applying the data distribution for the first agent to the one or more candidate agents, and applying the data distribution for the second agent to the one or more candidate agents.

29. A management node as claimed in claim 20, wherein operation (i) comprises selecting two agents for the set of similar agents for which there is at least a partial match between the respective input data required by the two agents, at least a partial match between the respective output data provided by the two agents, and at least a partial match between the parameters of the system improved by the two agents.

30. A management node as claimed in claim 20, wherein operation (ii) comprises comparing generator and discriminator neural networks that represent the data distribution for the first agent to generator and discriminator neural networks that represent the data distribution for the second agent to determine the relationship between the data distributions.

31. A management node as claimed in claim 30, wherein operation (ii) comprises using auto-encoders to compare the data distributions.

32. A management node as claimed in claim 20, wherein the determined relationship between the data distributions indicates whether (i) the data distribution for the first agent is identical or substantially identical to the data distribution for the second agent, (ii) the data distribution for the first agent is contained within the data distribution for the second agent, (iii) the data distribution for the first agent contains the data distribution for the second agent, or (iv) the data distribution for the first agent is disjoint from the data distribution for the second agent.

33. A management node as claimed in claim 32, wherein if the data distribution for the first agent is identical or substantially identical to the data distribution for the second agent, operation (iii) comprises:
(a) determining a candidate agent as a combination of the first agent and the second agent using federated averaging learning; or
(b) determining a first candidate agent by retraining the first agent using the data distribution for the first agent and the data distribution for the second agent, and determining a second candidate agent by retraining the second agent using the data distribution for the first agent and the data distribution for the second agent.

34. A management node as claimed in claim 32, wherein if the data distribution for the first agent contains the data distribution for the second agent, operation (iii) comprises:
(c) defining the first agent as a candidate agent to replace the second agent;
(d) determining a candidate agent by retraining the first agent using the data distribution from the first agent and the data distribution from the second agent; or
(e) determining a candidate agent by performing transfer learning for the first agent using the data distribution from the second agent.

35. A management node as claimed in claim 32, wherein if the data distribution for the second agent contains the data distribution for the first agent, operation (iii) comprises:
(f) defining the second agent as a candidate agent to replace the first agent;
(g) determining a candidate agent by retraining the second agent using the data distribution from the first agent and the data distribution from the second agent; or
(h) determining a candidate agent by performing transfer learning for the second agent using the data distribution from the first agent.

36. A management node as claimed in claim 32, wherein if the data distribution for the first agent and the data distribution for the second agent are disjoint, operation (iii) comprises:
(j) determining a candidate agent by training a candidate agent using the data distribution from the first agent and the data distribution from the second agent.

37. A management node as claimed in claim 20, wherein the system is a telecommunication network and the one or more parameters are operational parameters of the telecommunication network.

38.-55. (canceled)
